(19) United States
(12) Patent Application Publication
(10) Pub. No.: US 2007/0221025 A1
(43) Pub. Date: Sep. 27, 2007

(54) Crosscutting Tool for High-Speed Crosscutting

(76) Inventors: Hakan Olsson, Karlskoga (SE); Anders Dahlberg, Lerum (SE)

Correspondence Address: PILLSBURY WINTHROP SHAW PITTMAN, LLP, P.O. BOX 10500, MCLEAN, VA, 22102, US

(21) Appl. No.: 11/575,648

(22) PCT Filed: May 11, 2005
(86) PCT No.: PCT/SE05/00674

§ 371 Date: Mar. 26, 2007

(30) Foreign Application Priority Data
Sep. 28, 2004 (SE) 0402342-0

(51) Int. Cl. B26D 1/56

(52) U.S. Cl. 83/343

(57) ABSTRACT

The present invention relates to a crosscutting tool for high-speed crosscutting, which comprises a body having a through-hole for a rod to be cut, and a cutting edge delimiting at least a portion of said through-hole, wherein said cutting edge is formed by at least two cutting jaws positioned within, and supported by, said body.

### TECHNICAL FIELD

The invention relates to a crosscutting tool for high-speed crosscutting, which crosscutting tool comprises a body having a through-hole, for a rod (W) to be cut, and a cutting edge delimiting at least a portion of said through-hole.

### PRIOR ART

By virtue of, for example, U.S. Pat. No. 3,735,656, a tool device for high-speed crosscutting is previously known. The use of such a tool device to cut rod-like material by virtue of high energy-supply speed is therefore previously known. Despite a number of potential advantages with the method, it is not widespread and established within manufacturing industry. One of the reasons why this technique has not become established on a larger scale appears to be that the tool configuration was deficient and led to undesirable production stoppages. Just such a deficiency is that it was often not possible to obtain sufficiently good precision in terms of the alignment of the fixed and the movable tool. Common to conventional tool configurations is that the crosscutting tools, at least the movable crosscutting tool, was rectangular. For production engineering reasons, there has to be a certain clearance between the sides of the tools and the tool housing, both in the lateral direction and in the vertical direction. The measuring accuracy in respect of the centre hole for the material relative to the sides of the tool also demands a certain tolerance. All in all, this means that the position of the centre hole for the two tools is not certain to be exactly mutually aligned, which poses a problem when material is to be fed through the tool between each cut. Another deficiency is that known constructions used a type of helmet for transmitting the impact energy from the striking piston to the movable crosscutting tool, which is an undesirable construction from many aspects. Another drawback is that known constructions require removal of the tool housing in case of tool change and thereby gave undesirably long set-up times for the machine.

From WO 03086690 there is known a tool device for high-speed crosscutting, which eliminates the above mentioned disadvantages. This is achieved with a tool device for high-speed crosscutting, comprising a striking unit, a tool housing, a damper unit, a movable crosscutting tool and a fixed crosscutting tool, wherein in that the tool housing has at least two curved supporting surfaces for the movable crosscutting tool, which supporting surfaces have the same radius, and in that between the said supporting surfaces there is a recess for a striking piston belonging to the striking unit.

However, when crosscutting is to be performed in materials of extra strength, e.g. rod material for exhaust valves in Otto engines, it has shown to be difficult to achieve a desired operability. Sometimes, problems in the form of crack formation has occurred in the material, which is undesirable. Hence, the great diameter variations often present in the feed stock of greater diameters (>12 mm) and produced by rolling (as opposed to drawn and surface ground bars and wire, which show better dimensional accuracy) have proven to reduce the efficiency in the process, leading to the use of oversized machinery with increased energy consumption, noise levels and overall strain due to the larger forces and shocks invoked.

### SUMMARY OF THE INVENTION

It is an object of the present invention is to eliminate, or at least minimize, the above mentioned problem which is achieved by a crosscutting tool for high-speed crosscutting, which crosscutting tool comprises a body having a through-hole, for a rod (W) to be cut, and a cutting edge delimiting at least a portion of said through-hole, wherein said cutting edge is formed by at least two cutting jaws positioned within and supported by said body.

Thanks to the invention there is provided a crosscutting tool with improved abilities. By using two cutting jaws, in at least one of the counteracting crosscutting tools, the counteracting forces, which are produced during the cutting action (within the parting plane) will be divided into several directions through the rod. Consequently the forces acting within the parting plane of the rod will be more evenly distributed, which in turn will reduce the risk of formation of cracks and also reduce the deformation of the rod. Hence, the invention provides for substantial advantages, especially in relation to cutting operations for rods of extra strength and/or thickness and/or dimensional variation.

According to further aspects of the invention;
each one of said cutting jaws has a cutting edge having an extension (1) that corresponds to 5-45% of the circumference of the rod W to be cut, preferably about 10-24%, which provides for a favourable distribution of the edge portion of each jaw.
said edge is curved, wherein said curvature (rⱼ) is equal to or larger than, preferably slightly larger than, the curvature (r_{w}) of the rod (W), which provides for an advantageous contact between the cutting edge and the rod, when the rod has a circular outer configuration.
each one of said cutting jaws is arranged to be exchange ably mounted within said body, which is an essential cost advantage, since it facilitates merely exchanging one or several of the jaws without any need for exchange of the body of the crosscutting tool.
said body is arranged with a recess adapted to a portion of the outer configuration of each cutting jaw, preferably a portion positioned opposite the positioning of said cutting edge, which provides for favourable interaction between the body and the cutting jaw, e.g. since counter forces may be transferred them between without passing any sharp edges.
said configuration comprises a curved portion (rₛ), which is an especially favourable design of the outer configuration to achieve high strength/durability, e.g. since counter forces may be transferred them between without passing any sharp edges.
said curved portion has a constant radius (rₛ), which is efficient to machine and also provides for the possibility of having each jaw pivotally movable within the body.
adjustment means are arranged to provide for axial adjustability of the position of each cutting jaw for axial adjustment of the positioning of the cutting edge in relation to the body, which gives the advantage that a mere adjustment of the jaws may be sufficient to make the crosscutting tool reusable after wear, whereas according to traditional tools adjustment of the whole body (bodies) of the tool(s) would be needed. Also, the cut-off plane can be kept in the same position even after adjustment for wear, which is more difficult to achieve when the traditional tools are ground down after wear.
each cutting jaw is pivotally arranged within said recess, which provides the advantage that the jaws may “automatically” position themselves, by means of the counteracting forces, in a favourable position for performing a desired cutting operation of a rod.
a support means is arranged within said body, also delimiting a portion of said through hole, which provides the advantage of reducing any risk of the rod “whip lashing”, and also may assist in guiding the rod during insertion into the tool.
said support device is symmetrically positioned in relation to said cutting jaws, which provides advantageous positioning of the support device in relation to the cutting jaws.
at least two of, preferably each one of, said cutting jaws have the same configuration, which provides the cost efficient advantage that one and the same kind of jaws may be used for all of the jaws needed in a crosscutting tool, and indeed for both of the two counteracting crosscutting tools.
said body comprises two different materials, the said two different materials preferably being constituted by an inner and outer concentrically arranged, essentially annular unit, which provides flexibility.
a movable and fixed crosscutting tool of this kind is provided with curved surfaces having the same radius (R), which facilitates easy centering of the crosscutting tools.

### BRIEF DESCRIPTION OF THE FIGURES

The invention will be described in greater detail below with reference to figures of a prior art module unit as shown in WO 03086690 and of a preferred illustrative embodiment of a crosscutting tool according to the invention, in which:

FIG. 1 shows a perspective view obliquely from above of the prior art module unit,

FIG. 2 shows the same device in a perspective view from another direction,

FIG. 3 shows in perspective obliquely from above a tool housing belonging to the module unit,

FIG. 4 shows the same housing as FIG. 3 but directly from the front,

FIG. 5 shows the section A-A according to FIG. 4, having disposed therein crosscutting tools according to the invention,

FIG. 6 shows the movable crosscutting tool according to the invention seen in a side view from the front,

FIG. 7 shows the movable crosscutting tool according to the invention seen in a side view from behind,

FIG. 8 shows a fixed part of the movable crosscutting tool of FIGS. 6 and 7 in a perspective view,

FIG. 9 shows one of the adjusting parts of the tool according to FIGS. 6 and 7, seen in perspective,

FIG. 10 shows a further fixed part of the crosscutting tool of FIGS. 6 and 7, seen in perspective,

FIG. 11 shows the fixed crosscutting tool according to the invention, seen in a side view from the front,

FIG. 12 shows a fixed part of the fixed crosscutting tool according to FIG. 11,

FIG. 13 shows a perspective view of the two crosscutting tools according to the invention seen from above,

FIG. 14A-E show the successive way of operation of a cross-cutting tool according to the invention, and

FIG. 15A-B illustrate how a rod is affected when using a prior art, traditional way of cross-cutting tool, and

FIG. 16A-B illustrate the influence of the crosscutting tools on a rod when a method according to the invention is being used.

### DETAILED DESCRIPTION

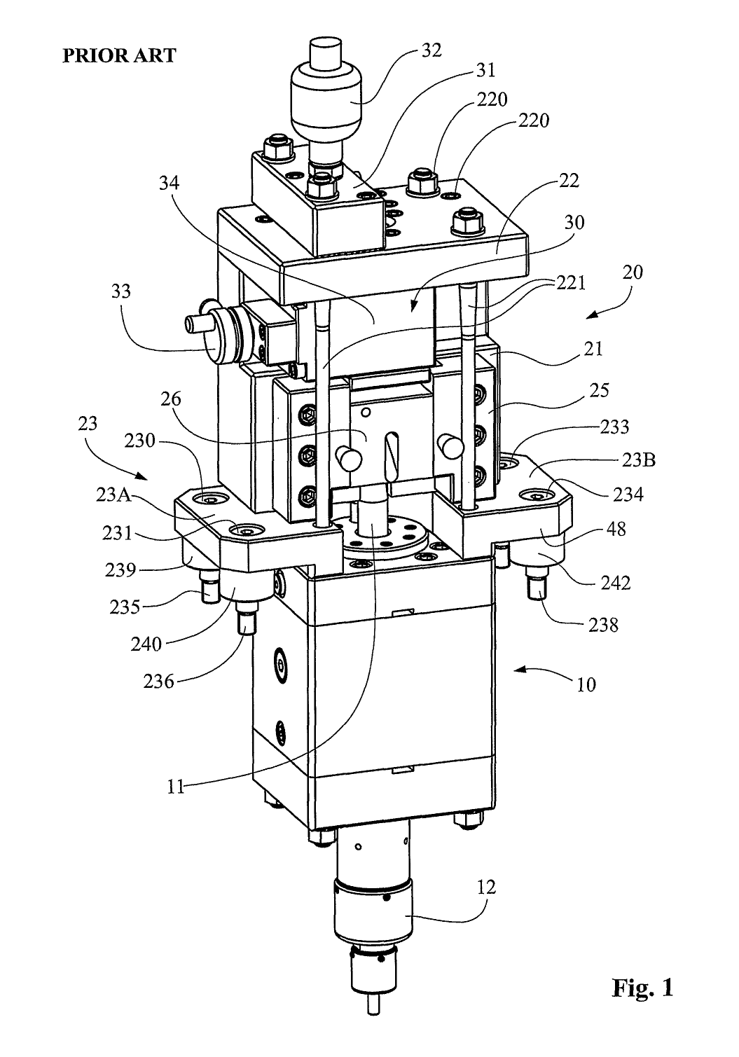

FIG. 1 shows in perspective view obliquely from above a prior art module unit tool device. The tool device comprises a striking unit 10, a tool housing 20 and a damper 30. Inside the tool housing 20 there are disposed a movable crosscutting tool 40 and a fixed crosscutting tool 50. A striking piston 11, which is driven by the striking unit 10, can administer to the movable crosscutting tool 40 from below an upwardly directed blow with high kinetic energy, in a manner which is known per se, the fixed crosscutting tool 50 exerting a detaining force upon the work piece to be cut (not shown). The damper 30 is arranged to brake the striking motion of the movable crosscutting tool 40 following completion of the cutting. The striking unit 10 and the damper 30, with associated damper housing 34, hydraulic block 31 and pressure accumulator 32, do not form part of this invention and will therefore not be described in depth. It can however be mentioned that the projecting wheeled member 33 on the damper 30 constitutes an adjusting mechanism for setting the desired damping, as well as that the cylindrical portion 12 projecting downward in the figure on the cylinder housing 10 constitutes a position indicator housing.

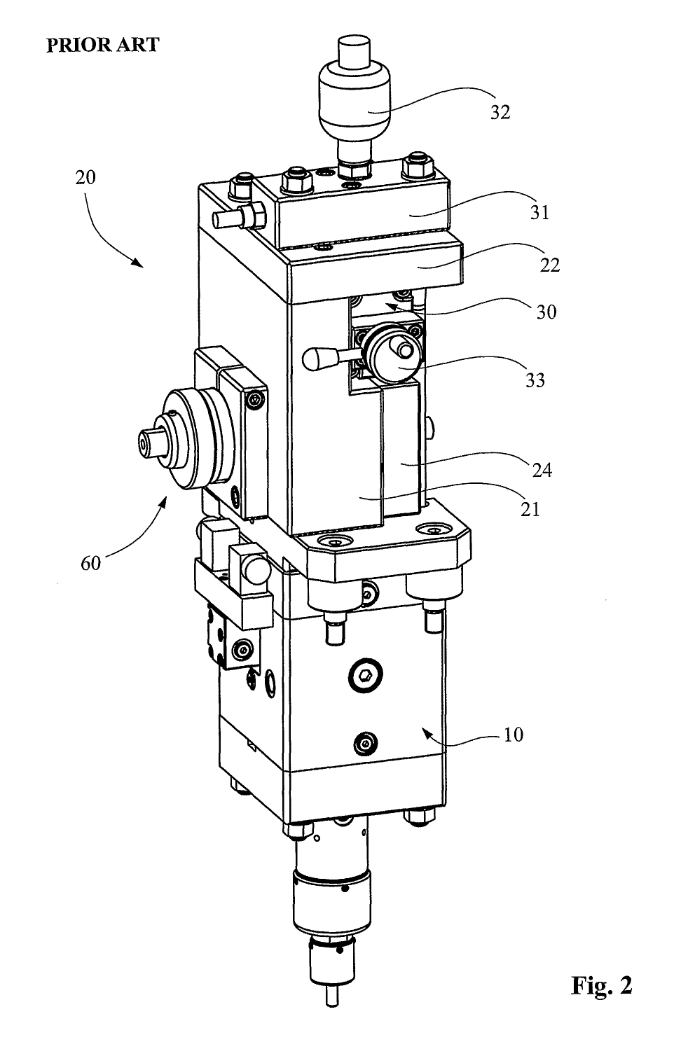

According to the illustrative embodiment shown, the tool module shown in FIG. 1 and FIG. 2 is arranged to cut cylindrical rods. For the purpose of guiding the rod which is to be cut, there is a rod-guiding unit 60, which is centrally placed on the back of the tool housing 20 (see FIG. 2). The tool housing 20 consists of a solid base element 21 on top of which there is a cover 22. The cover 22 is firstly fixed to the base unit 21 by means of screws 220 at its rear edge and secondly by means of stud bolts 221 at its front edge. These stud bolts also hold together other parts of the module, i.e. also the striking unit 10 and a base plate 23 belonging to the tool housing. The base plate 23 comprises a suspension arrangement 23, which enables quick and simple fitting and removal of the entire tool module.

The suspension arrangement on the said base plate 23 is solid and has a width exceeding the width of the actual tool housing 20. Projecting portions 23A, 23B are thus formed, on both sides of the tool housing 20. In each of these projecting portions 23A, 23B there are two holes 230, 231 and 232, 234 respectively, in which fitting bolts 235-238 are disposed. On these fitting bolts there are rubber pads 239-242. The fitting bolts 235-238 are designed to be fitted into matching holes in the actual crosscutting machine (not shown), whereby the tool device is fixed in the horizontal plane in the machine. Owing to the rubber pads, a certain resilience is allowed in the vertical direction, giving both sound insulation and vibration damping. Thanks to the solution involving fitting bolts, the facility is obtained for very fast and smooth changing of the entire module unit, whereby costly stoppages can be eliminated. In other known devices, the entire unit cannot be changed, according to requirement, without the need for a time-consuming removal of various component parts.

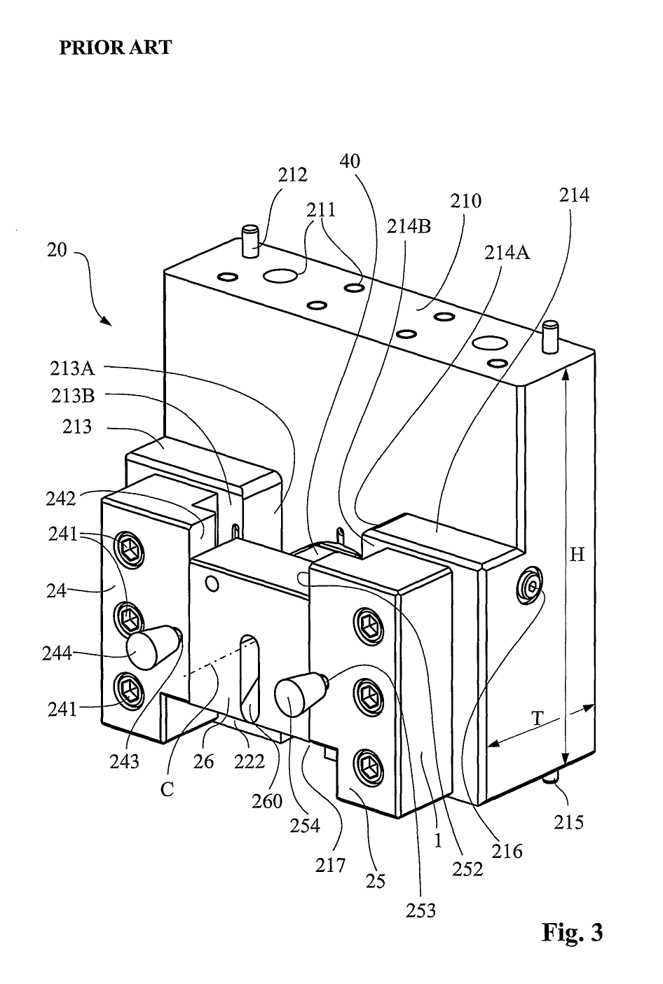

FIG. 3 shows essential parts of a tool housing 20 of the module unit of FIGS. 1 and 2. It can be seen that the base element 21 consists of a solid piece of relatively large height H and also of relatively large thickness T. Up on its end face 210 there are threaded holes 211 for fastening of the cover 22. In addition there are guide pins 212 arranged for exact positioning of the cover 22. On the front face of the base element there are arranged two heel-shaped portions 213 and 214, so that on each inwardly directed end face 213A and 214A there are formed parallel guide surfaces, which normally are positioned vertically, so that these guide surfaces 213a, 214a can prevent rotation of the movable crosscutting tool 40. To each of the heels 213 and 214 there is fastened a respective fixing member 24 and 25. These fixing appliances 24, 25, like the heels 213, 214, are configured wholly symmetrically with respect to a vertical plane of symmetry coinciding with the centre line C for the wire which is to be cut. Each fixing appliance 24, 25 is fixedly anchored to the respective heel 213 by means of three screws 241. The fixing appliance 24 has its lower surface level with the base unit 21 and extends right up to somewhat directly below the respective upper end face of the heels 213, 214. From an essentially rectangular main body part in the fixing appliance 24, supporting portions 242 and 252 project in toward the centre line C. Parallel with the centre line C, in each of the said supporting portions 242, 252, there are recesses 243 and 253. In the said recesses 243, 253, resilient locking appliances 244 and 254 respectively are disposed. With the aid of these locking appliances 244, 254, a supporting hatch 26 is fixed in the vertical direction. In the lateral direction and outward/forward, the hatch 26 is fixed by the respective fixing appliance 24, 25 and held inwardly in place by means of outwardly directed surfaces 213B, 214B of the heel members 213, 214. In the centre of the supporting hatch 26 there is a recess 260. In the bottom of the base element 21 are disposed guide pins 215 designed to fix the base element 21 in the bottom plate 23 to the tool device. In addition, FIG. 3 shows that on one face of the base element 21 there is a lubricating hole 216, for lubricating slide surfaces in the crosscutting device. Finally, in FIG. 3, a recess 217 is discernible in the bottom portion of the base unit 21, which recess 217 has a U shape and provides space for the striking piston 11 to penetrate up toward the movable crosscutting tool 40.

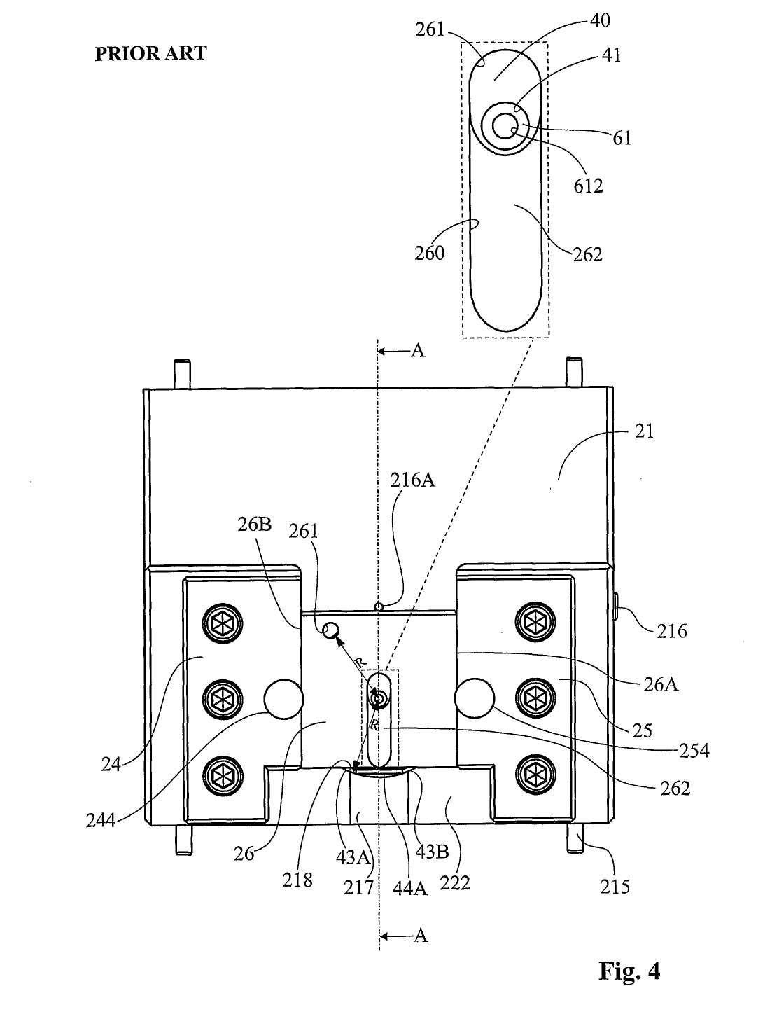

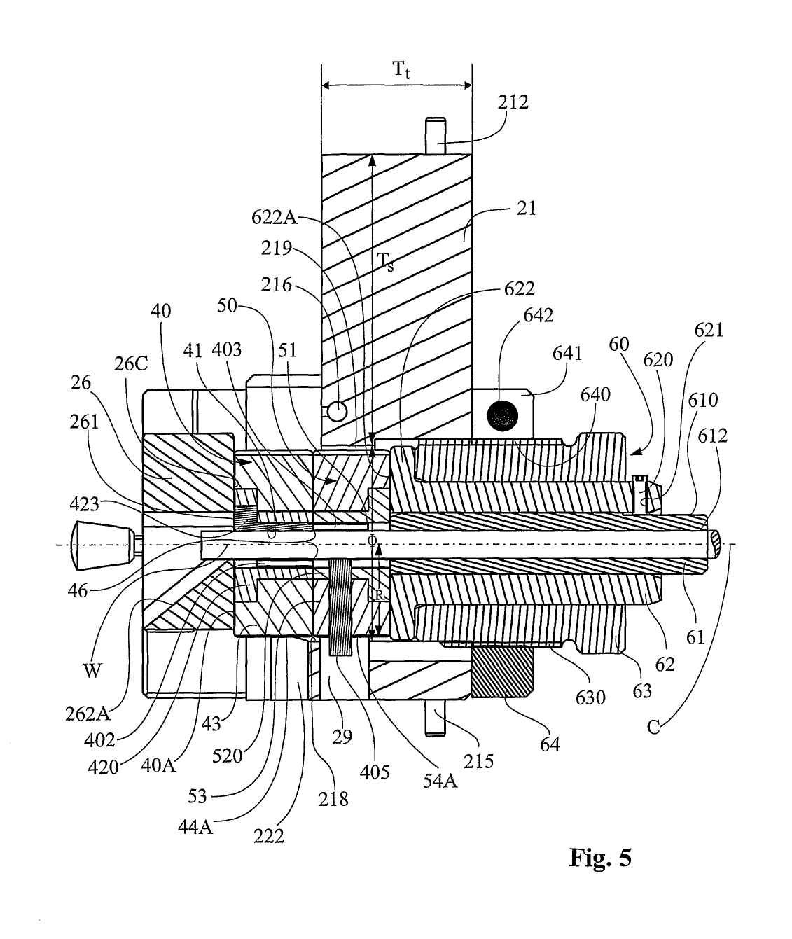

FIG. 4 shows a front view of the unit according to FIG. 3. It can be seen that the hatch at the ends of the front face is provided with edge portions 26A, 26B, which interact, with fit, with opposite-facing side faces of the supporting portions 242, 252. Unlocking of the locking appliances 244, 254 allows displacement of the hatch 26 in the vertical direction, i.e. parallel with the guide surfaces 26B, 26A. It can further be seen that the recess 260 disposed in the central part of the hatch 26 has an upper portion 26 which extends through the whole of the hatch. Downward in the direction out toward the front face from the said through-hole there is a downwardly directed recess 262, whereby a sloping bottom portion 262A is formed. In the extension of the through-hole 26, concentrically positioned, there is a through-hole 41, in the movable crosscutting tool 40, and behind this a through-hole 62 in a guide sleeve 61 (see FIG. 5). Emerging above the upper edge of the hatch 26 there is an opening 216A of the lubricating duct 216, so that lubricant can flow down toward purpose-made slide surfaces. In extension of the recess 217 for the striking piston 11, the bottom edge 44A of the movable crosscutting tool 40 is discernible. It is evident that the bottom edge forms a plane edge face 42, which is designed to receive the blow from the piston 11. It can further be seen that adjoining edge faces 43a, 43b constitute curved surfaces. These curved surfaces are configured with a given radius R. The same radius R is found in the surface 218, present in the base element 21, which is borne against by the radius-possessing lower surfaces of the crosscutting tools.

FIG. 5 shows a section along the line A-A in FIG. 4. It can be seen that the control unit 60 comprises an inner guide sleeve 61, which is centred in relation to the centre line C for the rod W which is to be cut. The guide sleeve 61 is, in turn, fixed inside a tensioning sleeve 62, concentrically. For the purpose of being able to fix the guide sleeve 61 inside the tensioning sleeve 62, the guide sleeve 61 is provided with a bevelled surface 610, designed to interact with a stop screw 620 which, threaded, is disposed in a hole 621 at the end of the tensioning sleeve 62. At the other end of the tensioning sleeve 62 there is a flange-like portion 622, which is wholly matched to the configuration of the hole 219 present in the base element 21. This hole is wholly cylindrical, with a certain radius R. Corresponding to this radius R is the radius R found in the curved edge portions, for example 43A, 43B of the striking tools 40, 50 (to be described in greater detail below). The flanged portion 622 of the tensioning sleeve 62 has a diameter which is essentially consistent with the diameter inside the hole 219 through the base element 21. For positioning of the tensioning sleeve and the flange 622, and hence the positioning surface 622A of the flange, a pressure screw 63 is provided, which is sleeve-shaped and is arranged concentrically on the outside of the tensioning sleeve 62. In the outer surface of the pressure screw 63 there is a thread 630. This thread 630 is designed to interact with a lock block 64 and a correspondingly threaded through-hole 640 in the lock block 64. The lock block 64 is fixed to the base element 21 by fixing screws. By providing the lock block 64 with a through-slot 641 and a threaded joint 642 interacting therewith, it is possible to adjust the clamping force from the thread 640 against the pressure screw 63 to the required level, from being able to run very easily to being able to fix the pressure screw 63 by clamping/friction force. By threading the pressure screw 63 to the desired position, the desired positioning of the guide surface 622A of the tensioning sleeve 62 is therefore obtained. At the same time, an exact centering of the centre line C through the hole 612 in the guide sleeve is obtained by the construction.

It can further be seen from FIG. 5 that the fixed crosscutting tool 50 comprises several parts, e.g. an outer sleeve-shaped part 53 and an inner sleeve shaped part 520. The outer sleeve 53 is chosen in a material which primarily is optimised with regard to being able to absorb large instantaneous force shocks without risk of plastic deformation or cracking (for example, tool steel with high impact strength). Correspondingly, the movable tool 40 also comprises several parts, e.g. an outer 43 sleeve-shaped part and an inner sleeve shaped part 420.

In FIG. 5 the fixed crosscutting tool 50 bears with its inner side surface against the guide surface 622A of the tensioning sleeve 62. The fixed tool 50 is positioned inside the cavity 219 in the base element 21 so that it is both rotationally secure and also in the transverse direction fixed in relation to the base element 21. Since the tool 50 is provided with four curved edge faces 53A, 53B, 53C, 53D which are exactly matched to the radius R of the through-hole 219, an exact positioning and alignment of the tool will be obtained. The centre line C for the rod W will therefore coincide with the centre line for the tool 50. Correspondingly, an identical positioning of the movable tool 40 is achieved by virtue of the latter, with its lower, radius-possessing surfaces 43A, 43B interacting with/bearing against the radius-possessing surface 218 of the part 222 of the base element which projects forward at the bottom and in which the U-shaped opening for the striking piston 11 is disposed. It can be seen from FIG. 5 that the opposite-facing surfaces of the movable and the fixed 50 tool are designed to slide relative to each other, which must occur in connection with cutting of a rod which has penetrated through the passage 51 of the fixed crosscutting tool 50 and also through the passage 41 of the movable tool 40. At the same time, a guidance takes place of the movable tool 40 on its opposite side 40A, by means of an inwardly directed surface 26C of the hatch 26. For the purpose of being able to prevent rotation of the fixed tool 50, a projecting portion of an adjustable support member 405 is used, which is designed to interact with the walls of a through hole 29 arranged in the bottom portion of the base element 21.

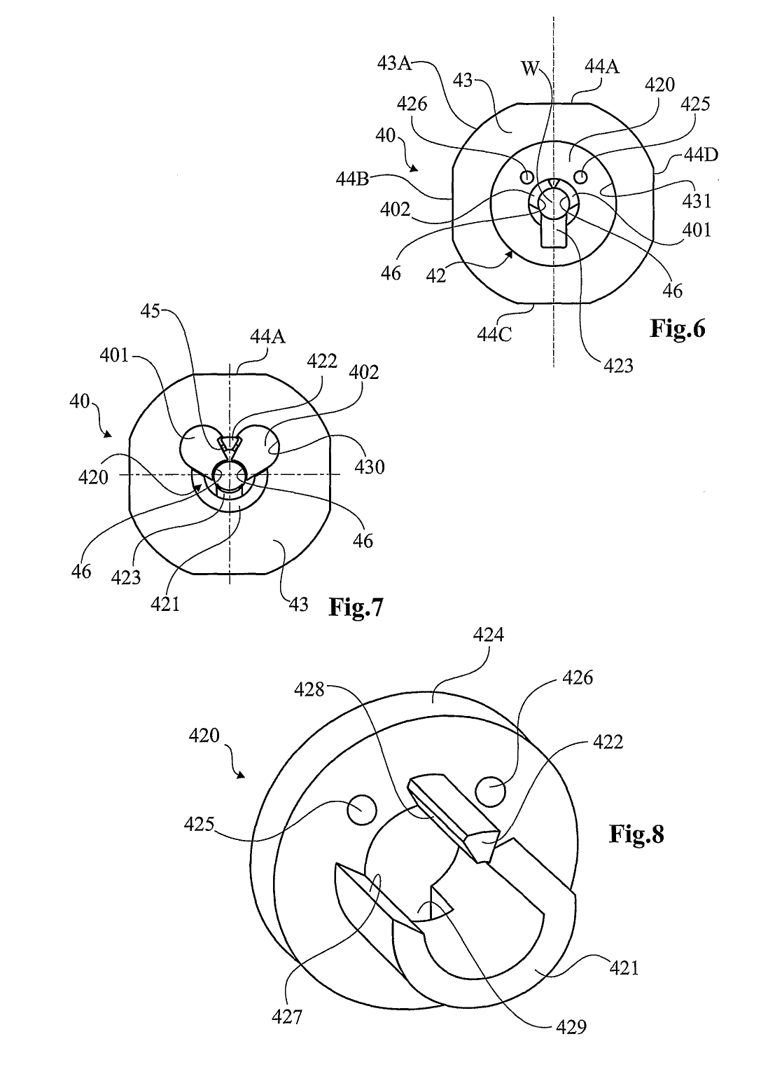

FIG. 6 shows a front view of a movable crosscutting tool 40 according to a preferred embodiment of the invention. However, in FIG. 6 the crosscutting tool 40 is shown “upside down”, in relation to the position of FIG. 5. The reason is that normally a crosscutting tool according to the invention is to be used in connection with work pieces W that need extraordinary high impact. As a consequence, in most cases, it is preferable to arrange the striking unit to act from above and downwardly, since normally such a powerfill striking unit will be too large to fit into the machine, to strike from below, without undertaking extra measures to create the required space, e.g. digging a hole in the ground. Accordingly more often this kind of crosscutting tools are used in connection with striking units striking from above. It is evident, however, for the skilled person, that it has no delimiting influence for the invention whether the striking unit is arranged to strike from below, from above or from the side.

The crosscutting tool 40 comprises an outer sleeve 43 and an inner sleeve 420, which are concentrically positioned in relation to each other. In the centre of the tool 40 there is a passage 41, which will allow the rod W of adapted diameter to pass through. As is best seen in FIG. 8 the inner sleeve 420 comprises an annular flange-like portion 424, the backside of which is shown in FIG. 6. From the flange-like annular portion 424 there protrudes, inwardly a semicircular sleeve portion 421 and a stub-like portion 422. On the opposite side of the flange-like portion 24 there is formed a rectangular recess 429. Moreover there are arranged two threaded through holes 425 and 426 through the annular flange-like portion 424. Within the rectangular recess 429 there is positioned an L-shaped support device 423 (see FIG. 10) that provides the function of maintaining the position of the rod W in one direction. To cut the rod W there are arranged two cutting jaws 401, 402. Each one of these jaws 401, 402, is positioned in the gap formed on each side between the sleeve-like portion 21 and the stub member 422.

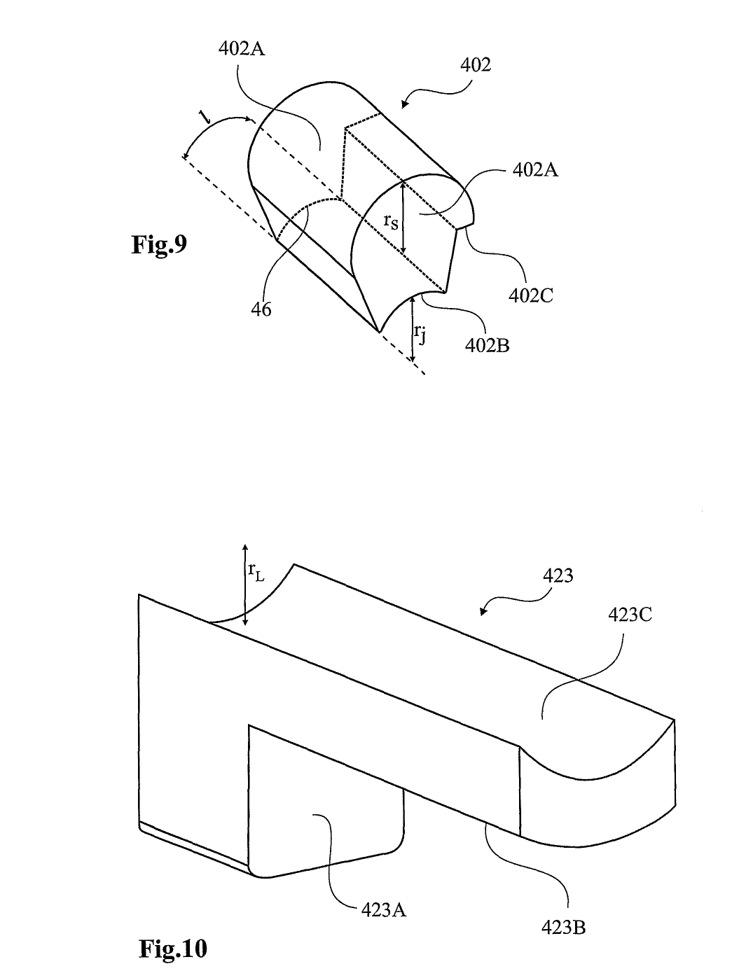

In FIG. 7 there is shown a view from the back of the movable crosscutting tool 40, i.e. showing the parting plane wherein the actual cutting action is performed. It can be seen that the cutting jaws 401, 402 are arranged within curved recesses 430 within the outer sleeve portion 43. The recesses 430 are exactly adapted to the curvature of the curved outer wall 402A (see FIG. 9) of each crosscutting jaw 401, 402. Thereby it is possible for each jaw 401, 402 to slightly rotate within its recess 430. FIG. 7 also shows that resilient elements 45 are arranged between the stub portion 422 and each crosscutting jaw 401, 402. These resilient elements 45 will act upon the jaws 401, 402 to rotate outwardly, i.e. to abut the upper surface 427 of the sleevelike protruding portion 421. To be able to position each crosscutting jaw 401, 402 in a desired plane in relation to the parting plane, there are arranged adjustment screws (not shown) within the through holes 425, 426, such that by means of adjusting the screws the front end of it will abut the rear wall of the cutting jaw, whereby the exact desired position of the cutting edge 46 of each jaw 401, 402 is achieved. Hence each jaw 401, 402 is exactly positioned in the axial direction at the same time as they may pivot slightly distance within each recess 430, about an imaginary axis that is parallel with the centre line C of the rod W.

In FIG. 9 there is shown a perspective view of one of the crosscutting jaws 402. Here the rearward side 402A of the jaw 402 is facing outwardly, i.e. that side of the jaw that is interacting with the front end of the adjustment screw within the through hole 426. It is also shown that there is a kind of edgelike formation 402C, which is intended to create space for and interact with the protruding stub portion 422. The concave curvature r; of the inwardly exposed surface of each jaw 401, 402, is the same as or slightly larger that the radius r_{w} of the rod W that is to be cut. Hereby it is achieved that the pressure acting from the jaws (during the cutting operation) will be evenly distributed along and across the rod W, to perform a desired cut along the cutting edges 46. The extension 1 of the cutting edge 46 of one jaw is shown to be about 20-24% of the circumference of the rod W.

In FIG. 10 it is shown that the L-formed support piece 423 also is arranged with a concave surface 423C, that has a curvature r_{L} which generally corresponds with the curvature rⱼ of the jaws.

An advantage with the outer shape of the crosscutting tool 40 is that the curved surfaces 43A can be made with very high precision using conventional, cost-effective machine-working, for example turning. Since these curved surfaces 43A are used for positioning/alignment of the crosscutting tool 40 in the tool housing 20, this means that very high precision with respect to alignment, i.e. the arrangement of the through-hole 41 along a predetermined axis C through the tool, can easily be obtained. The plane surfaces 44A of the crosscutting tool 40 is used to take the blow from the striking piston 11 and also, on the opposite side 44C, for braking the motion of the crosscutting tool 40, towards the damper unit 30, after the blow has been executed. As can be seen from FIG. 10, sharp edges of the tool 40 are eliminated by virtue of their beveling.

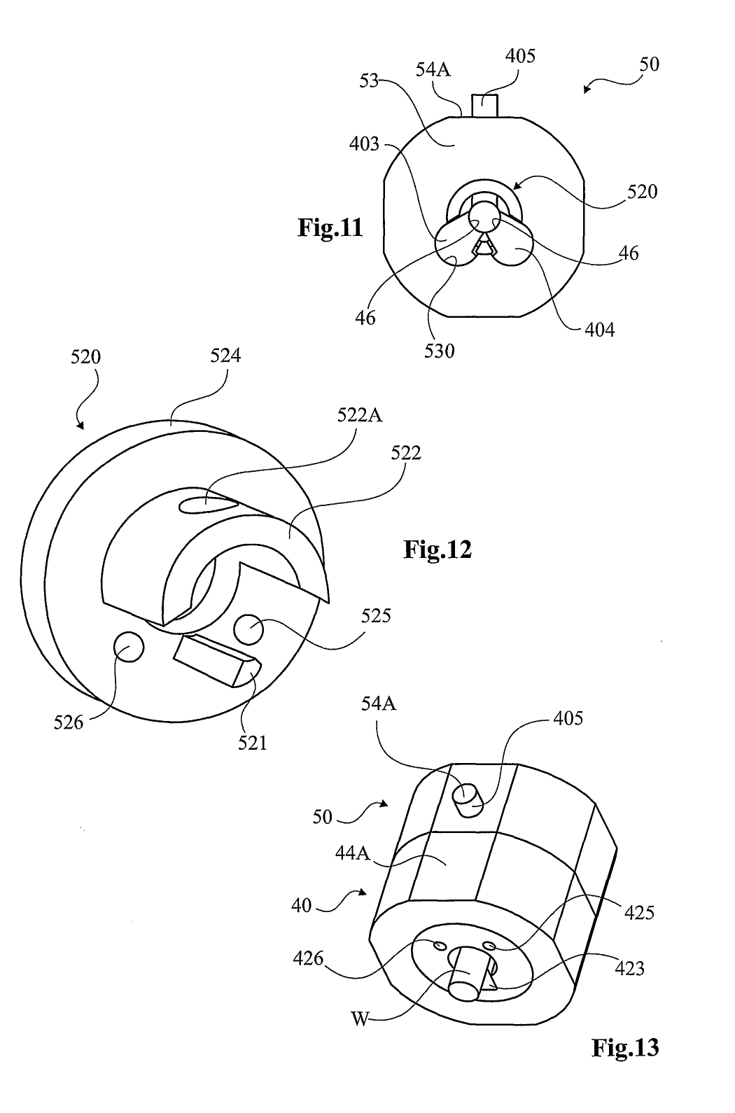

FIG. 11 shows a fixed crosscutting tool 50 in a front view. It can be seen that the fixed crosscutting tool 50, according to a preferred embodiment, has exactly the same outer configuration as the movable crosscutting tool 40, which is rational in view of many aspects and, inter alia, reduces the production costs. Moreover, the fixed tool also consists of an inner sleeve 520 and outer sleeve 53 body.

As can be seen in FIG. 11 also the fixed tool 50 is arranged with two cutting jaws 403, 404. In contrast to the movable tool 40, these crosscutting jaws 403, 404 are positioned on the lower most side within the outer sleeve 53. The basic design of the inner sleeve 520, as seen in FIG. 12, is substantially the same for the fixed tool 50 as for the movable tool. Also the arrangement within curved recesses 530 within the outer sleeve 53 is similar for the fixed tool 53. Generally, there is only one difference between the movable tool and the fixed tool, in the basic design. In the fixed tool 50, an adjustable rodlike member 405 is used as a support whereas a L-shaped device 423 fulfils that function in the movable tool 40. However also the rodformed support device 405 is arranged with an end surface (not specifically shown) having a curvature that is similar to the curvature of the jaws rⱼ. FIG. 12 also shows that there is a hole 522A arranged for passage of the support rod 405, through the inner sleeve 520.

In FIG. 13 there is shown a perspective view of the two cutting tools 40, 50 positioned next to each other, i.e. shown in their working position. Here the striking surface 44a of the movable tool 40 is directed upwardly, as has been mentioned before being preferable if a large striking unit is being used. In connection with what is shown in FIG. 5, however, the cutting tools 40, 50 have been positioned upside down (compared to FIG. 13) since there the striking unit is mounted below the crosscutting tools 40, 50.

In FIG. 5 it can further be seen how the tool unit, comprising the movable crosscutting tool 40 and the fixed crosscutting tool 50, is positioned within the crosscutting machine, when the striking unit strikes from below. As is evident from FIG. 5, the cutting jaws 402, 403 extend in the axial direction a limited distance in relation to the total width of a crosscutting tool 40, 50. By means of the adjusting means 425, 426; 525, 526 (threaded bores) having adjustment screws therein (not shown) the exact positioning of the cutting edges 46 may be achieved. A further advantage of this adjustment possibility is that the cutting jaws may be used also after wear. Furthermore the existence of these through holes 425, 426; 525, 526 also makes it easy to exchange a cutting jaw. It is evident that this is a major advantage of a crosscutting tool according to the invention, since traditionally a major part of a damaged tool would have to be exchanged. Moreover the ability of merely exchanging the crosscutting jaws and possibly also the support members 405, 423, makes it feasible to use one and the same body to cut rods W of different sizes, since it is possible to produce a number of cutting jaws having exactly the same shape at the rear end, i.e. curvature and width, but having different length and/or a radius, rⱼ, at the cutting edge 46. The object of the support members 405, 423 are mainly to eliminate any kind of “whiplash” effect when a cutting operation is performed. Thanks to the slight pivoting action of the cutting jaws they will “automatically” be positioned in an optimal position during the cutting operation.

When the tool is in use, the parts are assembled as shown in FIGS. 1 and 2. Moreover, as previously described, the entire module unit 10, 20, 30, 40 and 50 is fixed in a crosscutting machine (not shown) by the fitting bolts 236-239. With the aid of a specially adapted feed device, the rod-shaped material W is then fed in through the cavity 612 in the guide sleeve 61 and then further in through the passage 51 in the fixed crosscutting tool 50 and finally also through the passage 41 in the movable crosscutting tool 40. The crosscutting machine is then ready to be started, which means that the striking unit 10 causes the piston 11 to accelerate upward so as finally to hit the striking face 44A (see FIG. 5) of the movable tool 40 with high energy/velocity. The movable crosscutting tool 40 is then accelerated upward away from the striking piston 11. As is evident from FIGS. 7 and 11, the cutting jaws 401-404 are positioned on opposite sides of a horizontal plane containing C, one pair 401, 402, of the movable tool 40, being positioned below said horizontal plane and the other pair 403, 404 being positioned above said horizontal plane. Hence, once the movable crosscutting tool 40 starts to move in an upward direction (due to the blow from below) the cutting jaws 401, 402 will get into contact with the lower most side of the rod W, which will create a counterforce by the cutting jaws 403, 404 in the fixed tool 50. Accordingly a squeezing action will occur, whereby forces will be applied from four different directions, substantially symmetrically, divided around the conference of the rod W within the parting plane. Thanks to the cutting jaws 401-404 being slightly movable within their recesses 430, 530 each cutting edge 46 will automatically be positioned so as to transfer the counterforce evenly onto the surface of the rod W. Consequently the counteracting forces produced by the cutting jaws 401-404 will prevent any compression in merely one direction (as occurs when using traditional cutting tools) but will distribute the forces and thereby generally maintain the form of the rod W during the cutting operation. Thanks to this action by the cutting jaws the risk of formation of cracks is reduced. Hence, a crosscutting tool according to the invention is especially advantageous to use when cutting rod material of high strength and/or large cross section.

Next the crosscutting tool 40 is damped by the damper unit 30, as a result of the upper plane surface 44C of the tool bearing against a movable unit (not shown) belonging to the damper 30 so that the striking motion is retarded, after which the crosscutting tool is returned to the striking position as a result of the tool being pressed constantly downward, by the said movable unit in the damper, toward the striking position. Owing to the guide surfaces 26E, 26F in the hatch, which interact with the side-orientated plane surfaces 44B, 44D, the crosscutting tool will be prevented from being able to rotate, whereby the same curved surfaces 43A, 43B come into contact again with the curved surfaces 218 of the base element 21. To a certain extent, and in certain cases totally, the rotational securement can be achieved by interaction between the upper plane surface 44C and the movable pressing appliance (not shown) belonging to the damper 30. Since the interacting surfaces between the base element 21 and the movable crosscutting tool 40 are configured with the same radius R, an exact positioning/alignment of the movable crosscutting tool will be effected. Any dirt which is loosened with the blow will be able to disappear down through the recess 217 in the base element 21, thereby further ensuring that an exact positioning/alignment can be achieved. The fixed crosscutting tool 50 is held in place during the blow by the fact that its four end faces 53A-53D, possessing the radius R, are exactly fitted in the circular recess 219 in the base element 21. From this viewpoint also, it is advantageous for precision reasons to use radiuses, since even a radius in a solid piece is relatively easy to produce with high precision, compared with other multidimensional shapes. A very good fit can thus be obtained between the fixed crosscutting tool 50 and the recess 219 in the base element 21, which is advantageous from both a mechanical viewpoint and from a durability viewpoint.

Once the movable crosscutting tool 40 is back in place, a new desired length of the rod material W can be inserted into the through-hole 41 of the movable crosscutting tool 40. As a consequence hereof, the cut rod bit will be moved out of the hole 41 and will slide in the cavity 260 in the hatch 26, along the inclined plane 262A, so as then to be suitably collected.

By removing the hatch 26 the movable crosscutting tool 40 is exposed, so that the striking tools 40, 50 can be easily picked out in the direction of the wire in the opening created by the removal of the hatch 26. The crosscutting tool 40, 50 can thus be quickly and easily inspected/exchanged and/or adjusted.

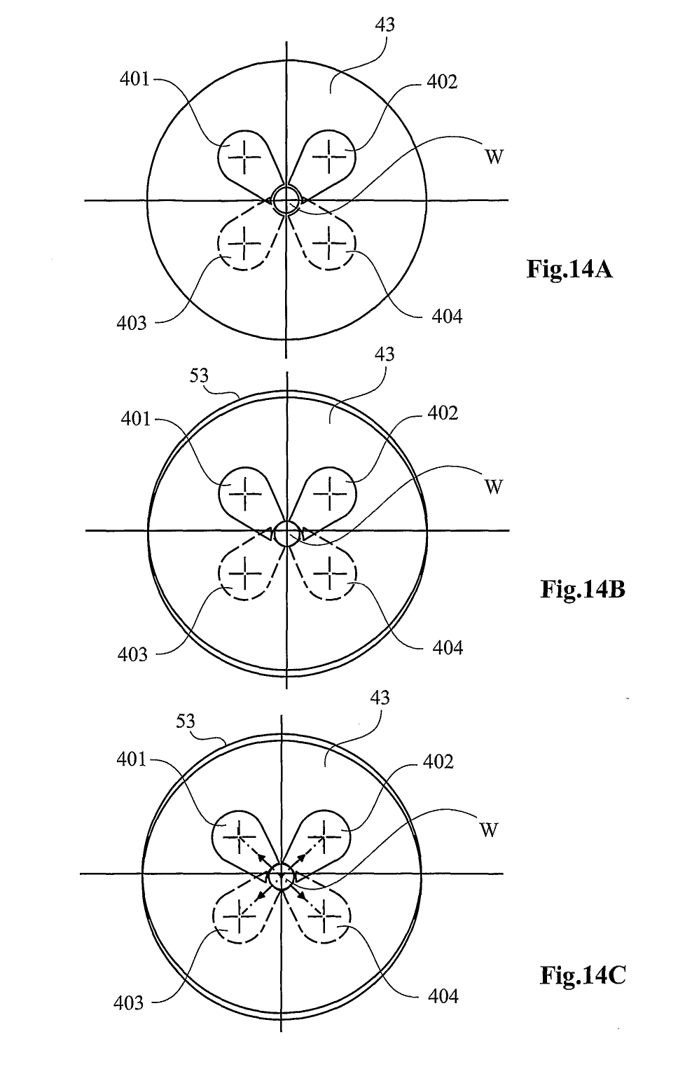

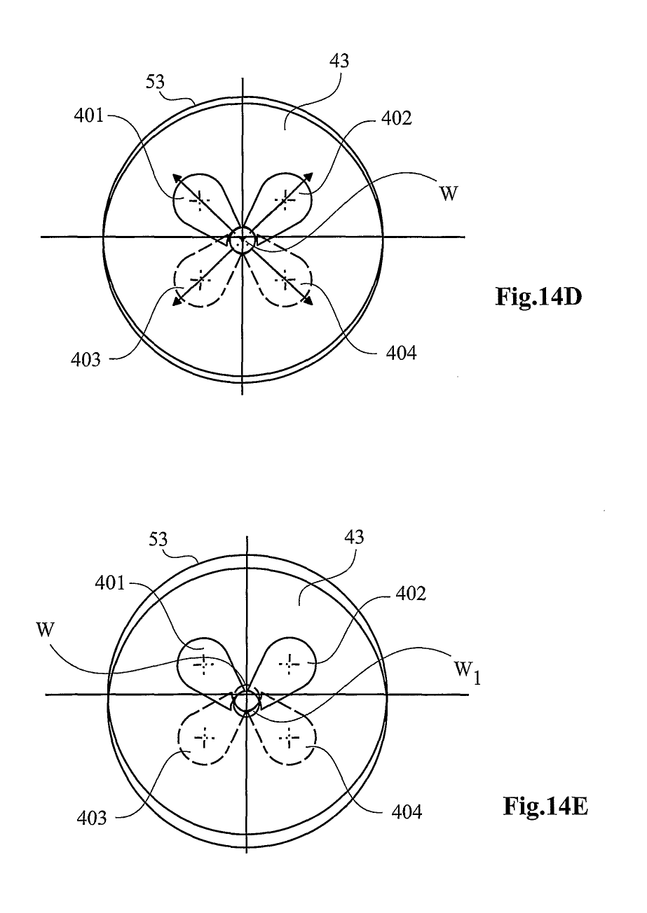

In FIG. 14A-E there is shown, in a consecutive manner, how crosscutting of a rod is performed in accordance with the invention.

In FIG. 14A the feeding position is shown, i.e. the two crosscutting tools 43, 53 being positioned coaxially in relation to each other, such that the crosscutting jaws 401, 402 of the movable crosscutting tool 43 are positioned slightly above, at a distance from the rod W and the crosscutting jaws 403, 404 of the fixed crosscutting tool 53 (behind the movable tool 43) are positioned slightly below the rod W. Hence it is possible to feed the rod W in this position.

FIG. 14B illustrates the situation shortly after the movable crosscutting tool 43 has been impacted upon, from above. Here, the movable tool 43 has been pressed slightly downwardly (preferably by a separate press unit), such that the jaws 401, 402, 403, 404 get in contact with the rod W. In this position the jaws 401-404 have not rotated, but maintained in their unaffected position, such that the jaws are in contact with the rod at their edges.

In FIG. 14C it is illustrated that the movable tool 43 has been pressed further downwards by the pressing unit to get into striking position with the rod W, thereby also having moved the rod to get into the striking position with the cutting jaws 403, 404 of the fixed tool 53, leading to counteracting forces being created. During this pressing action the jaws 401-404 will also rotate to be optimally positioned in relation to the rod. It is illustrated that the counteracting forces, in accordance with the invention, will be created in four orthogonal directions, i.e. influencing the rod W by crosscutting forces that are distributed at four different locations of the circumference of the rod W. Hence, in this position the cutting jaws are optimally positioned to perform the crosscutting action.

In FIG. 14D it is illustrated when the actual-crosscutting is performed, and how the forces are transmitted from the crosscutting jaws 401-404 to the rod W, when the adiabatic crosscutting action is achieved.

In FIG. 14E there is shown the position of the crosscutting tools 43, 53 shortly after the crosscutting action has been fulfilled. Accordingly the movable crosscutting tool 43 has proceeded its downward movement to bring along the piece of rod WI that has been cut off from the rod W. From this position the movable tool will be returned to the starting position, as shown in FIG. 14A, where the crosscutting tools 401, 404 are no longer in direct contact with the rod W. Thereafter (or in conjunction herewith) the rod W can be advanced into the movable crosscutting tool 43 to thereby also push the cut off piece W out of the tool, and a new crosscutting action can be performed.

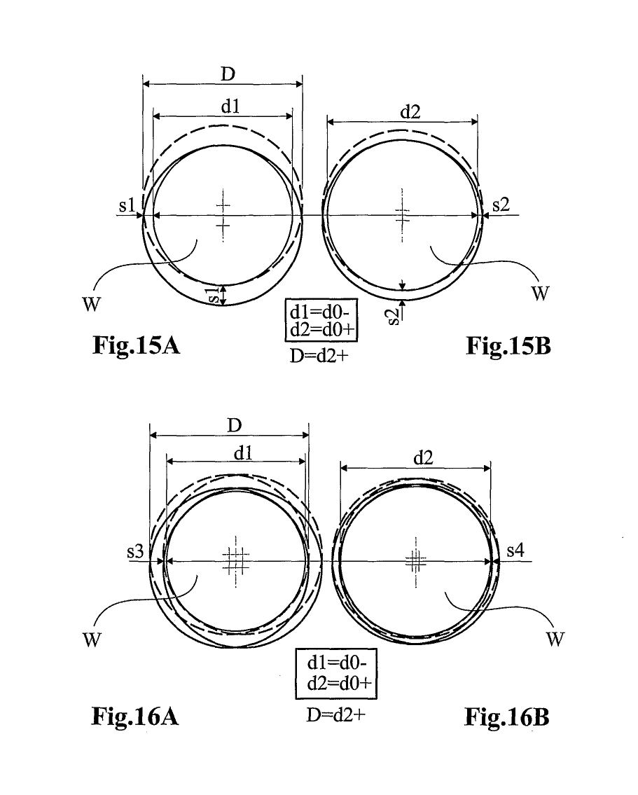

In FIGS. 15A-B and FIGS. 16A-B there is illustrated, by way of comparison, the improved achievements of the invention concerning the influence of the crosscutting action, by comparing the use of a traditional method (FIG. 15A-B) and the invention (FIG. 16A-B). In FIGS. 15A-B there is shown how a traditional crosscutting tool will influence the distribution of material of a rod W that is being crosscut. In FIG. 15A it is illustrated a rod W that is going to be crosscut by the use of a traditional method, using one upper crosscutting jaw and one under crosscutting jaw. Prior to crosscutting the rod W has the same diameter D1 in all directions. The rod W is being cut by an upper and under cutting jaw having crosscutting surfaces with a curvature that corresponds to a diameter D that is substantially larger than D1, which is needed to be able to feed the rod into the crosscutting tool. The difference in curvature of the rod W and the crosscutting tool lead to a gap S1 being obtained at each side, between the rod and the inner wall of the crosscutting tools. During the striking action of the crosscutting tools the rod W will flex to fill the void S1. After the crosscutting action is terminated the rod W will flex back, due to its inert flexibility. However due to some plastic deformation of the rod W there will remain a certain amount of deformation which leads to an increase of the cross-sectional distance D2 of the rod in the horizontal plane. Accordingly the rod W will not flex back all of the distance S1 of the gap but merely a fraction S2 of that distance. Hence the rod W will obtain an oval configuration in a cross-section after a cutting performance, has been performed according to a traditional method.

In FIGS. 16A-B there is illustrated in a corresponding manner how a rod W will be influenced during the cutting action when using a method according to the invention. Hence it can be seen that thanks to the use of a crosscutting method according to the invention, whereby the rod W is affected at four different locations by the crosscutting tools along its circumferential periphery, the gap S3 into which the rod W may flex is considerably smaller than if a traditional method is being used. Hence the remaining deformation S4 will be considerably smaller thanks to the use of a method according to the invention.

The invention is not limited by the above illustrated but can be varied within the scope of the following patent claims. It will thus be realised, for example, that the advantageous design of the crosscutting tools can also be utilised in connection with conventional, rectangular crosscutting tools. It will further be realised that the invention, in certain contexts, can be usable in a combination of a movable, radius-possessing crosscutting tool and a fixed crosscutting tool of conventional cross-sectional configuration. It will additionally be realised that the movable tool 40 can be configured so that symmetry only exists along one plane. Furthermore it is evident for the skilled person that more than two crosscutting jaws may be used in each one of the tools 40, 50, e.g. three or four, depending on the actual need. It is also evident that many different kind of materials may be used. It is also evident that in some cases it will not be needed to use an inner and an outer sleeve for the body of the crosscutting tool, but that the recesses for crosscutting jaws and supporting device may be arranged directly within a homogenous body, e.g. by arranging the jaws of the fixed part directly into the structure of the housing 20, e.g. into the solid base element 21 of the tool housing 20. It is evident that also the configuration of the inner sleeve may vary substantially without departing from the scope of the claims. Moreover it is evident that the principle described may also be used for the cutting operations of other kind of rods than shown, e.g. non-round rods, tube-formed rods, square and/or hexagonal rods.

According to a modification according to what is shown above it is evident that the jaws of the movable crosscutting tool may be arranged to be axially movable within the movable crosscutting tool. By such an arrangement the crosscutting jaws will be allowed to move axially during a crosscutting action, i.e. to be able to follow an axial movement of the rod W. By the use of such an arrangement it will be feasible to perform crosscutting of a rod material that is continuously fed, for instance in connection with production by means of rotary straighteners. This arrangement may also be used to facilitate an even higher production rate, since it will facilitate to start moving the rod W in the axial direction at an earlier stage than if the crosscutting jaws within the movable rod are axially non-movable. The movable jaws will be influenced by a retracting force (preferably continuously acting, e.g. a resilient means such as a spring, gas pressure and/or some hydraulically intermittently acting means) to be able to quickly reposition the jaws axially, into the crosscutting position, prior to the subsequent crosscutting action, i.e. to quickly regain the starting position. It is also evident that the retraction of the movable jaws may be actively controlled by an automatic control unit.

1. Crosscutting tool for high-speed crosscutting, which crosscutting tool comprises a body having a through-hole, for a rod to be cut, and a cutting edge delimiting at least a portion of said through-hole, wherein said cutting edge (is formed by at least two cutting jaws positioned within and supported by said body.

2. Crosscutting tool according to claim 1, wherein each one of said cutting jaws has a cutting edge with an extension that corresponds to 5-45% of the circumference of the rod to be cut, preferably about 10-24%.

3. Crosscutting tool according to claim 2, said edge is curved, wherein said curvature is equal to or larger than, preferably slightly larger than, the curvature of the rod.

4. Crosscutting tool according to, claim 1, wherein each one of said cutting jaws is arranged to be exchangeably mounted within said body.

5. Crosscutting tool according to claim 4, wherein said body is arranged with a recess adapted to a portion of the outer configuration of each cutting jaw, preferably a portion positioned opposite the positioning of said cutting edge.

6. Crosscutting tool according to claim 5, wherein said configuration comprises a curved portion.

7. Crosscutting tool according to claim 6, wherein the said curved portion has a constant radius.

8. Crosscutting tool according to claim 1, wherein adjustment means are arranged to provide for axial adjustability of the position of each cutting jaw for axial adjustment of the positioning of the cutting edge in relation to the body.

9. Crosscutting tool according to claim 1, wherein each cutting jaw is pivotally arranged within said recess.

10. Crosscutting tool according to claim 1 wherein a support means is arranged within said body, also delimiting a portion of said through hole.

11. Crosscutting tool according to claim 10, wherein said support device is symmetrically positioned in relation to said cutting jaws.

12. Crosscutting tool according to claim 1, wherein at least two of, preferably each one of, said cutting jaws have the same configuration.

13. Crosscutting tool according to claim 1, wherein the said body comprises two different materials, the said two different materials preferably being constituted by an inner and outer concentrically arranged, essentially annular unit.

14. Crosscutting tool according to claim 9, wherein a movable and fixed crosscutting tool of this kind is provided with curved surfaces having the same radius.

15. Crosscutting jaw for a crosscutting tool for high-speed crosscutting, being adapted to be used in a crosscutting tool according to claim 1.
